(19) United States
(12) Patent Application Publication
(10) Pub. No.: US 2013/0093619 A1
(43) Pub. Date: Apr. 18, 2013

(54) APPARATUS AND METHOD FOR INDOOR POSITIONING

(71) Applicant: Electronics and Telecommunications Research Institute, Daejeon (KR)

(72) Inventors: In One JOO, Daejeon (KR); Sang Uk LEE, Daejeon (KR)

(73) Assignee: Electronics and Telecommunications Research Institute, Daejeon (KR)

(21) Appl. No.: 13/646,186

(22) Filed: Oct. 5, 2012

(30) Foreign Application Priority Data
Oct. 7, 2011 (KR) 10-2011-0102507
Mar. 22, 2012 (KR) 10-2012-0029305

(51) Int. Cl. G01S 19/11

(52) U.S. Cl. CPC G01S 19/11
USPC 342/357.48

(57) ABSTRACT

Provided is a technique for estimating an indoor position, by which a terminal may receive a positioning signal from a pseudo satellite, using a plurality of receiving antennas, determine a position of the pseudo satellite based on positional information included in the received positioning signal, estimate a direction of the pseudo satellite based on a phase difference of the positioning signal at each of the plurality of receiving antennas, and estimate a location of the terminal based on the positional information of the pseudo satellite and the estimated direction of the pseudo satellite.

### CROSS-REFERENCE TO RELATED APPLICATIONS

This application claims the benefit of Korean Patent Application No. 10-2011-0102507, filed on Oct. 7, 2011, and Korean Patent Application No. 10-2012-0029305, filed on Mar. 22, 2012, in the Korean Intellectual Property Office, the disclosures of which are incorporated herein by reference.

### BACKGROUND

1. Field of the Invention

The present invention relates to an indoor positioning technology, and more particularly, to a technology for measuring an indoor position using a positioning signal transmitted from a pseudo satellite not synchronized according to time.

2. Description of the Related Art

Verifying a position of a user is attracting attention as an important technology. Among positioning technologies for verifying a position of a user, the only satellite navigation system currently commercialized is the Global Positioning System (GPS). The GPS system was developed by the U.S. Department of Defense, and has been used in applications for not only the military sector but also the civilian sector, for example, guided weapons, navigation, measurement, cartography, geodetic surveys, time synchronization, and the like. A GPS receiver has recently been generalized, and is combined with a portable terminal, for example, a portable multimedia player (PMP), a Moving Picture Experts Group (MPEG) Audio Layer 3 (MP3), a smart phone, and the like, to be used for a location-based service (LBS), a geographic information system (GIS), tracing of a moving object, telematics, and the like. In particular, a plan for compulsory mounting of a GPS in a smart phone has been discussed, and now a GPS is mounted in a smart phone requisitely.

The GPS system has an advantage of a remarkably high accuracy in positioning. However, since a GPS signal may not be received indoors or in a shadow area in which tall buildings are concentrated, the GPS system may be unusable. Accordingly, an indoor positioning technique using a pseudo satellite has been provided.

A pseudo satellite may refer to a satellite which enables positioning indoors or in a place in which receiving a GPS satellite signal may be difficult due to a concentration of tall buildings, by transmitting a positioning signal similar to a positioning signal transmitted by a GPS satellite. The GPS system may measure a position, based on a travel time of a signal from a satellite to a terminal, that is, a time of arrival (TOA). Accordingly, an expensive high-precision cesium clock may be used for time synchronization between GPS satellites. However, since a cheap clock, for example, a temperature compensated crystal oscillator (TCXO) may be used for a pseudo satellite, time may not be synchronized among pseudo satellites. Accordingly, a technology for time synchronization between pseudo satellite signals has been provided.

In a conventional technology, since a clock of a pseudo satellite may not be synchronized, a technology for resolving an expected issue by transmitting, from a separate reference station to a moving object, carrier wave phase correction information and a pseudo distance caused by time between pseudo satellites not being synchronized, and computing a position of the moving object based on the correction information. However, since a separate reference station is to be installed, in addition to a pseudo satellite, and a separate wireless channel is to be used for transmitting correction information generated by the reference station, a system may be complex and installation and operation costs may increase.

In a technology without using a reference station, time synchronization between pseudo satellites may be maintained by synchronizing clocks of remaining pseudo satellites with a clock of a pseudo satellite selected as a main pseudo satellite, among pseudo satellites. That is, in the foregoing technology, one of the pseudo satellites may be employed as a main pseudo satellite, and the other sub-pseudo satellites may maintain time synchronization with the main pseudo satellite. In order to implement the technology, a clock synchronization loop filter means may generate a command for clock synchronization of all the sub-pseudo satellites, and the sub-pseudo satellites may receive, through a separate channel, the command for clock synchronization from the clock synchronization loop filter means, and may synchronize clocks through a digitally controlled numerical controlled oscillator means. Similarly, when the technology is used to commercialize a pseudo satellite, a system may be complex and installation and operation costs may increase.

### SUMMARY

An aspect of the present invention provides an apparatus and method for accurate indoor positioning at a low cost.

Another aspect of the present invention also provides an apparatus and method for positioning using pseudo satellites not synchronized according to time.

According to an aspect of the present invention, there is provided a terminal, including a receiving unit to receive a first positioning signal from a first pseudo satellite, and to receive a second positioning signal from a second pseudo satellite, using a plurality of receiving antennas, a direction estimating unit to estimate a direction of the first pseudo satellite based on a phase difference of the first positioning signal at the plurality of receiving antennas, and to estimate a direction of the second pseudo satellite based on a phase difference of the second positioning signal at the plurality of receiving antennas, a positional information extracting unit to extract positional information of the first pseudo satellite by decoding the first positioning signal, and to extract positional information of the second pseudo satellite by decoding the second positioning signal, and a position estimating unit to estimate a position of the terminal, based on the extracted positional information of the first pseudo satellite, the extracted positional information of the second pseudo satellite, the estimated direction of the first pseudo satellite, and the estimated direction of the second pseudo satellite.

Here, the first pseudo satellite and the second pseudo satellite may be disposed indoors.

Each of the plurality of receiving antennas may be disposed a predetermined distance apart from one another.

The first positioning signal and the second positioning signal may be encoded using different pseudo random noise (PRN) codes.

The positional information of the first pseudo satellite may include at least one of longitude information, latitude information, and altitude information of the first pseudo satellite, and the positional information of the second pseudo satellite may include at least one of longitude information, latitude information, and altitude information of the second pseudo satellite.

According to another aspect of the present invention, there is provided a pseudo satellite including a transmitting unit to transmit, to a terminal, a positioning signal including positional information of the pseudo satellite. Here, the positioning signal may be received using a plurality of receiving antennas of the terminal, and the positional information and a direction of the pseudo satellite, estimated based on a phase difference at each of the plurality of receiving antennas, may be used to estimate a position of the terminal.

Here, the positional information may include at least one of longitude information, latitude information, and altitude information of the pseudo satellite.

A second positioning signal may be transmitted from a second pseudo satellite to the terminal, and received using the plurality of receiving antennas. A direction of the second pseudo satellite, estimated based on a phase difference of the second positioning signal at each of the plurality of receiving antennas, may be used to estimate the position of the terminal.

The second positioning signal may include positional information of the second pseudo satellite, and the positional information of the second pseudo satellite may be used to estimate the position of the terminal.

The transmitting unit may encode the positioning signal using a PRN code, and may transmit the encoded positioning signal.

According to still another aspect of the present invention, there is provided a method of estimating a position of a terminal, the method including receiving a positioning signal from each of a plurality of pseudo satellites, using a plurality of receiving antennas, estimating a direction of each of the plurality of pseudo satellites, based on a phase difference of the positioning signal at each of the plurality of antennas, extracting positional information of each of the plurality of pseudo satellites, by decoding the positioning signal, and estimating the position of the terminal, based on the extracted positional information of each of the plurality of pseudo satellites, and the estimated direction of each of the plurality of pseudo satellites.

Here, each of the plurality of receiving antennas may be disposed a predetermined distance apart from one another.

Positioning signals may be encoded using different PRN codes.

In addition, the positional information of each of the plurality of pseudo satellites may include at least one of longitude information, latitude information, and altitude information of each of the plurality of pseudo satellites.

According to an exemplary embodiment of the present invention, an accurate position may be measured indoors, at a low cost.

According to an exemplary embodiment of the present invention, a position may be measured using pseudo satellites not synchronized according to time.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating an indoor positioning system according to an exemplary embodiment of the present invention;

FIG. 2 is a diagram illustrating a terminal according to an exemplary embodiment of the present invention;

FIG. 3 is a diagram illustrating a process of estimating a direction of a pseudo satellite based on a phase difference between signals received at each antenna according to an exemplary embodiment of the present invention;

FIG. 4 is a block diagram illustrating a configuration of a terminal according to an exemplary embodiment of the present invention;

FIG. 5 is a block diagram illustrating a configuration of a pseudo satellite according to an exemplary embodiment of the present invention; and

FIG. 6 is a flowchart illustrating an indoor positioning method according to an exemplary embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

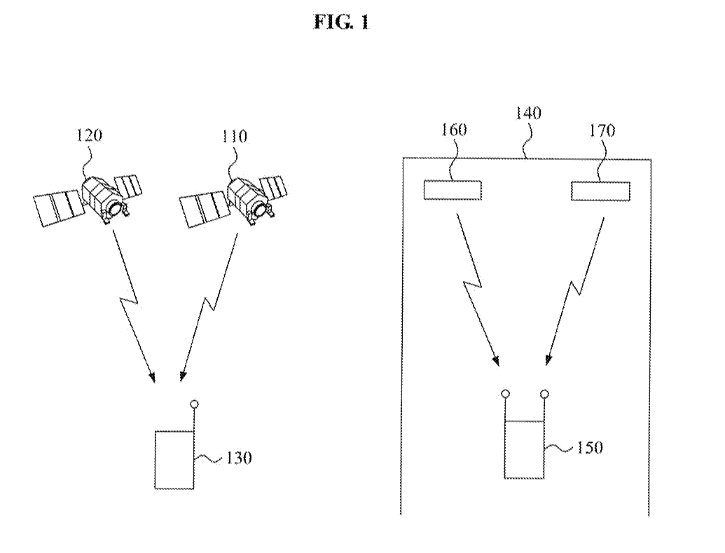

FIG. 1 is a diagram illustrating an indoor positioning system according to an exemplary embodiment of the present invention.

In a conventional positioning system, an outdoor terminal 130 may receive positioning signals from a satellite 110 and a satellite 120. The positioning signals may be synchronized with each other, and each of the positioning signals may include positional information of a corresponding satellite. The outdoor terminal 130 may estimate a distance from the satellite 110 to the outdoor terminal 130 and a distance from the satellite 120 to the outdoor terminal 130, based on the respective received positioning signals.

When the outdoor terminal 130 receives positioning signals from at least three satellites including the satellite 110 and the satellite 120, the outdoor terminal 130 may verify an accurate position of the outdoor terminal 130.

However, when an indoor terminal 150 is positioned inside a building 140, the indoor terminal 150 may fail to receive positioning signals from the satellite 110 and the satellite 120. Accordingly, the indoor terminal 150 may fail to estimate a position of the indoor terminal 150.

According to an exemplary embodiment of the present invention, the indoor terminal 150 may receive positioning signals from a pseudo satellite 160 and a pseudo satellite 170 installed indoors. The indoor terminal 150 may receive the positioning signals from the pseudo satellite 160 and the pseudo satellite 170, using a plurality of receiving antennas, and may estimate a direction of the pseudo satellite 160 and a direction of the pseudo satellite 170, which may be determined based on the indoor terminal 150, respectively. In addition, each of the positioning signals received from the pseudo satellite 160 and the pseudo satellite 170 may include positional information of a corresponding pseudo satellite.

When the indoor terminal 150 receives the positioning signals from the plurality of pseudo satellites 160 and 170, respectively, the indoor terminal 150 may extract, from the received positioning signals, the positional information of the respective corresponding pseudo satellites 160 and 170, and may estimate the position of the indoor terminal 150 based on the extracted positional information of the pseudo satellite 160, the extracted positional information of the pseudo satellite 170, the estimated direction of the pseudo satellite 160, and the estimated direction of the pseudo satellite 170.

A method of estimating the position of the indoor terminal 150 which fails to receive positioning signals from the satellite 110 and the satellite 120 will be described herein. Hereinafter, the indoor terminal 150 will be simply referred to as a terminal.

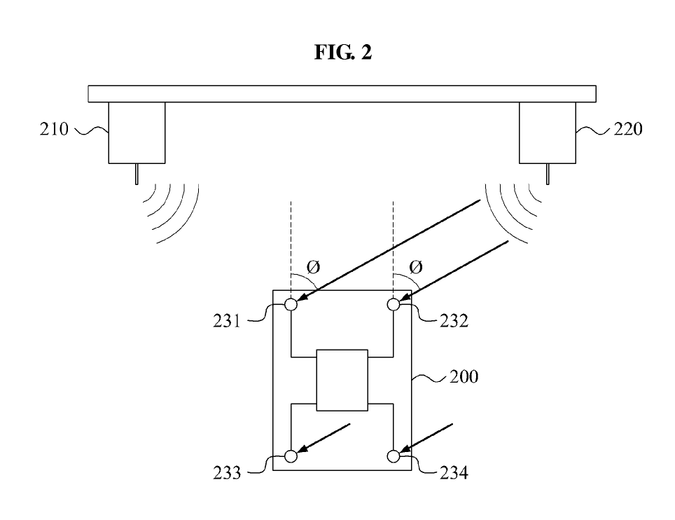

FIG. 2 is a diagram illustrating a terminal 200 according to an exemplary embodiment of the present invention.

Referring to FIG. 2, the terminal 200 may include a plurality of receiving antennas 231, 232, 233, and 234, and may receive positioning signals from a pseudo satellite 210 and a pseudo satellite 220, using the plurality of receiving antennas 231, 232, 233, and 234, respectively. The terminal 220 may estimate a direction of the pseudo satellite 210 and a direction of the pseudo satellite 220, which may be determined based on the terminal 200, using the received positioning signals, respectively.

The pseudo satellite 210 and the pseudo satellite 220 may be installed in a space in which a positioning signal may not be received from a satellite positioned outdoors, for example, in an indoor space. The pseudo satellite 210 and the pseudo satellite 220 may generate positioning signals similar to a positioning signal of the satellite positioned outdoors, respectively. Each of the positioning signal of the pseudo satellite 210 and the positioning signal of the pseudo satellite 220 may include positional information of a corresponding pseudo satellite.

The terminal 200 may receive the positioning signals from the pseudo satellite 210 and the pseudo satellite 220, using the plurality of receiving antennas 231, 232, 233, and 234, respectively. Each of the plurality of receiving antennas 231, 232, 233, and 234 may be disposed a predetermined distance apart from one another.

When the positioning signals received from the pseudo satellite 210 and the pseudo satellite 220 enter the plurality of receiving antennas 231, 232, 233, and 234, at an incidence angle of φ, a phase difference may occur between the positioning signals received through the plurality of receiving antennas 231, 232, 233, and 234. The terminal 200 may estimate a direction of the pseudo satellite 210 and a direction of the pseudo satellite 220, which may be determined based on the terminal 200, using the phase difference between the positioning signals received using the plurality of receiving antennas 231, 232, 233, and 234, respectively.

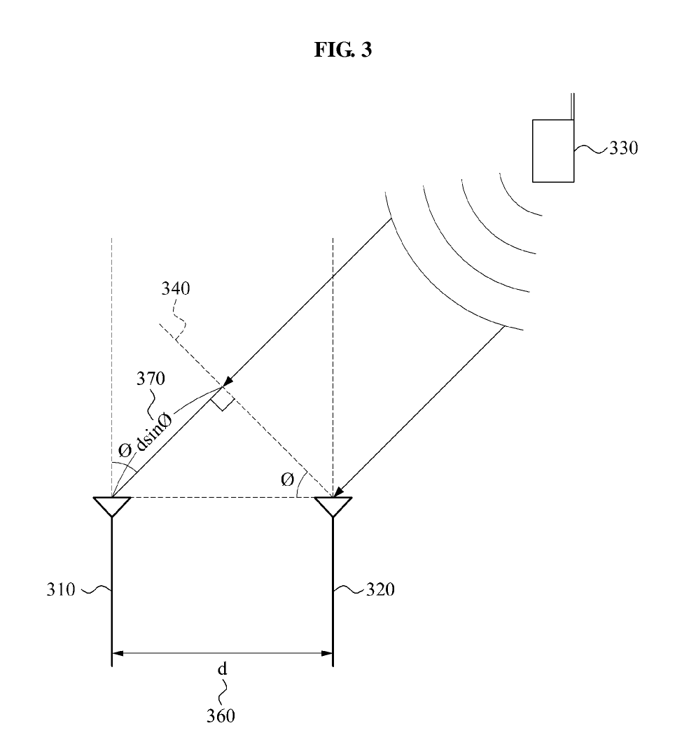

A process of estimating the direction of the pseudo satellite 210 and the direction of the pseudo satellite 220, which may be determined based on the terminal 200, using the phase difference between the positioning signals received through the plurality of receiving antennas 231, 232, 233, and 234, respectively, will be further described with reference to FIG. 3.

Each of the positioning signals received from the pseudo satellite 210 and the pseudo satellite 220, respectively, may include positional information of a corresponding pseudo satellite. The positional information may refer to information about a geographical position of the corresponding pseudo satellite, and may include, for example, at least one of longitude information, latitude information, and altitude information of the corresponding pseudo satellite.

Each of the pseudo satellite 210 and the pseudo satellite 220 may encode a positioning signal, using a unique code determined for each of the pseudo satellite 210 and the pseudo satellite 220. The terminal 200 may verify which pseudo satellite transmits a predetermined positioning signal, using the unique code determined for each of the pseudo satellite 210 and the pseudo satellite 220.

The terminal 200 may verify a geographical position of the pseudo satellite 210 based on the positional information included in the positioning signal of the pseudo satellite 210, and may verify a geographical position of the pseudo satellite 220 based on the positional information included in the positioning signal of the pseudo satellite 220. Also, the terminal 200 may estimate the direction of the pseudo satellite 210 and the direction of the pseudo satellite 220, which may be determined based on the terminal 200, based on the positioning signals, having different phases, which are received through the plurality of receiving antennas 231, 232, 233, and 234, respectively.

The terminal 200 may compute back to the position of the terminal 200, based on the verified geographical position of the pseudo satellite 210, the verified geographical position of the pseudo satellite 220, the estimated direction of the pseudo satellite 210, and the estimated direction of the pseudo satellite 220. For example, when a positioning signal is received from a single pseudo satellite, for example, one of the pseudo satellites 210 and 220, the terminal 200 may estimate the position of the terminal 200 to be a point on a straight line(*a straight line connecting the single pseudo satellite and the terminal 200). However, when a number of pseudo satellites from which positioning signals are received increases, the terminal 200 may estimate the position of the terminal 200 with greater accuracy.

As an example, each of the pseudo satellite 210 and the pseudo satellite 220 may use a frequency in an L1 band, and may encode a positioning signal using a unique pseudo random noise (PRN) code that may be determined for each of the pseudo satellite 210 and the pseudo satellite 220. In this instance, a rate of the PRN code may correspond to 1.023 megahertz (MHz).

As another example, each of the pseudo satellite 210 and the pseudo satellite 220 may use a frequency in an L2 band or an L5 band corresponding to a frequency band of a GPS system. In addition, a PRN code having a rate of 10.23 MHz may be used. Here, various modifications may be made to a frequency of a pseudo satellite and a rate of a PRN code, depending on navigation systems using a pseudo satellite, and such modifications may be obvious to those skilled in the art. Accordingly, the present invention is not to be construed as being limited to a specific pseudo satellite frequency and a specific rate of a PRN code.

In addition, although it has been described that the pseudo satellite may transmit a positioning signal of the GPS system, the pseudo satellite may also transmit a positioning signal of a Galileo system, and a combined Galileo/GPS system.

FIG. 3 is a diagram illustrating a process of estimating a direction of a pseudo satellite based on a phase difference between signals received at each antenna according to an exemplary embodiment of the present invention.

A technique for estimating the direction of the pseudo satellite based on the phase difference to be described with reference to FIG. 3 is known as interferometry.

Referring to FIG. 3, a first receiving antenna 310 and a second receiving antenna 320 may be disposed a predetermined distance d 360 apart from each other. A positioning signal having a wavelength of λ may be transmitted from a pseudo satellite 330.

When the pseudo satellite 330 is a great distance apart from a terminal, it may be construed that the positioning signal transmitted from the pseudo satellite 330 may enter in direction parallel to each of the first receiving antenna 310 and the second receiving antenna 320. That is, a first positioning signal received through the first receiving antenna 310 and a second positioning signal received through the second receiving antenna 320 may have an identical angle of incidence. Hereinafter, it may be assumed that a positioning signal may enter at an angle of φ based on a central angle of the terminal. That is, the pseudo satellite 330 may be positioned in a direction of φ based on the terminal.

An incidence plane 340 may correspond to a virtual plane generated by connecting points which may be positioned an identical distance apart from the pseudo satellite 330. When the first positioning signal and the second positioning signal reach the incidence plane 340, simultaneously, a phase of the positioning signal may be identical to a phase of the second positioning signal. Herein, it may be assumed that the incidence plane 340 may be generated by connecting points positioned at a distance corresponding to a distance between the pseudo satellite 330 and the second receiving antenna 320.

The second positioning signal may be received at a second phase, using the second receiving antenna disposed on the incidence plane 340. The first positioning signal may pass through the incidence plane 340, and may proceed further to the first receiving antenna 310. Accordingly, a phase of the first positioning signal may be changed from a phase on the incidence plane 340, in proportion to a further distance 370.

When a distance between the first receiving antenna 310 and the second receiving antenna 320 corresponds to d, and an incidence angle of a positioning signal corresponds to φ, degree of the change from the phase on the incidence plane 340 to the phase of the first positioning signal received from the first receiving antenna 310 may be computed, using Equation 1.

λ:d sin φ=2π:ΔΨ [Equation 1]

In Equation 1, λ denotes a wavelength of the positioning signal, d denotes a distance between the first receiving antenna 310 and the second receiving antenna 320, and φ denotes the angle of incidence of the positioning signal. ΔΨ denotes the degree of the change of the phase of the first positioning signal, based on the phase on the incidence plane 340.

ΔΨ may be derived from Equation 1, as expressed by Equation 2.

$$Δ Ψ = \frac{d sin φ \cdot 2 π}{λ} = ( 2 π d / λ ) sin φ \qquad [ Equation 2 ]$$

That is, the phase of the first positioning signal received through the first receiving antenna 310 may be rotated by ΔΨ from the phase of the second positioning signal received through the second receiving antenna 320. The terminal may compute back to the incidence angle φ of the positioning signal based on ΔT in Equation 2, as expressed by Equation 3.

φ=sin⁻¹(ΔΨλ/2πd) [Equation 3]

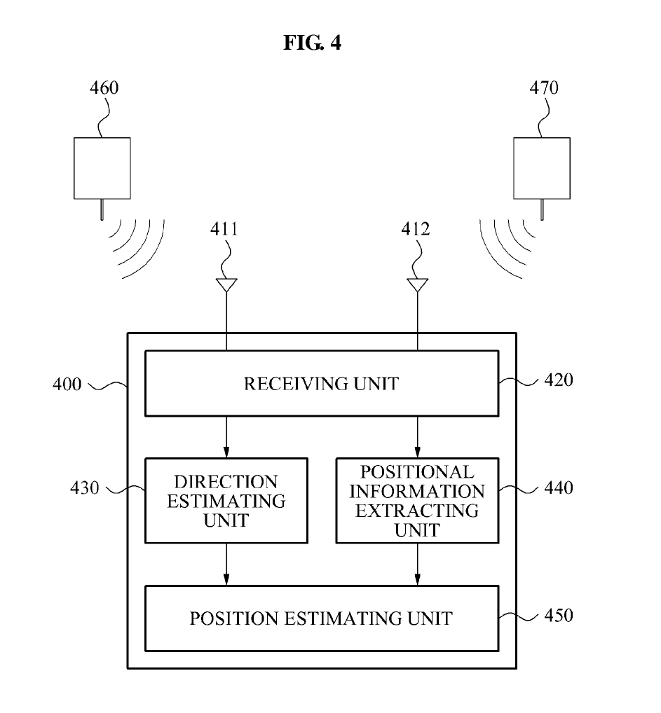

FIG. 4 is a block diagram illustrating a configuration of a terminal 400 according to an exemplary embodiment of the present invention.

Referring to FIG. 4, the terminal 400 may include a plurality of receiving antennas 411 and 412, a receiving unit 420, a direction estimating unit 430, a positional information extracting unit 440, and a position estimating unit 450.

The receiving unit 420 may receive a first positioning signal from a first pseudo satellite 460, and may receive a second positioning signal from a second pseudo satellite 470, using the plurality of receiving antennas 411 and 412. The plurality of receiving antennas 411 and 412 may be disposed a predetermined distance apart from each other. The first pseudo satellite 460 and the second pseudo satellite 470 may be disposed indoors. Also, the receiving unit 420 may perform a process of synchronizing a carrier frequency of a positioning signal.

The first positioning signal may be encoded using a first PRN code, and the second positioning signal may be encoded using a second PRN code. Although a PRN code may be decoded readily using a corresponding PRN code, the PRN code may not be decoded using another PRN code. In this instance, the receiving unit 420 may decode each of the first positioning signal and the second positioning signal, using a PRN code applied to a corresponding positioning signal, and may verify from which pseudo satellite each of the first positioning signal and the second positioning signal is transmitted.

The direction estimating unit 430 may estimate a direction of the first pseudo satellite 460, based on a phase difference of the first positioning signal at the plurality of receiving antennas 411 and 412. The direction estimating unit 430 may estimate a direction of the second pseudo satellite 470 based on a phase difference of the second positioning signal at the plurality of receiving antennas 411 and 412. The process of estimating a direction of a pseudo satellite based on a phase difference at each receiving antenna has been described with reference to FIG. 3 and thus, detailed descriptions will be omitted for conciseness.

Each of the first positioning signal and the second positioning signal may include positional information of a corresponding pseudo satellite. The positional information extracting unit 440 may extract positional information of the first pseudo satellite 460 by decoding the first positioning signal, and may extract positional information of the second pseudo satellite 470 by decoding the second positioning signal. Here, the positional information for each of the first pseudo satellite 460 and the second pseudo satellite 470 may refer to information about a geographical position of each of the first pseudo satellite 460 and the second pseudo satellite 470, and may include longitude information, latitude information, and altitude information of each of the first pseudo satellite 460 and the second pseudo satellite 470.

The position estimating unit 450 may estimate a position of the terminal 400, based on the extracted positional information of the first pseudo satellite 460, the extracted positional information of the second pseudo satellite 470, the estimated direction of the first pseudo satellite 460, and the estimated direction of the second pseudo satellite 470.

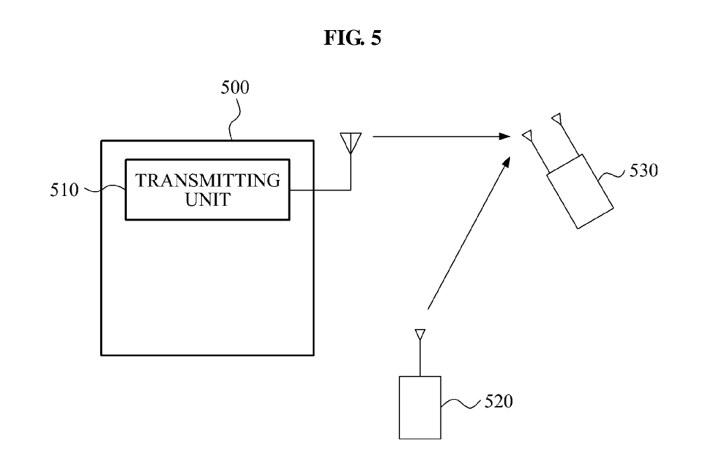

FIG. 5 is a block diagram illustrating a configuration of a pseudo satellite 500 according to an exemplary embodiment of the present invention.

Referring to FIG. 5, the pseudo satellite 500 may include a transmitting unit 510.

The transmitting unit 510 may transmit a positioning signal to a terminal 530. The positioning signal may include positional information of the pseudo satellite 500. Here, the positional information of the pseudo satellite 500 may refer to information about a geographical position of the pseudo satellite 500, and may include at least one of longitude information, latitude information, and altitude information of the pseudo satellite 500.

The terminal 530 may include a plurality of receiving antennas. In this instance, the positioning signal may be received using the plurality of receiving antennas of the terminal 530. Positional signals received using the plurality of receiving antennas may have a phase difference. A direction of the pseudo satellite 500, which may be determined based on the terminal 530, may be estimated using the positional signal received using the plurality of receiving antennas.

The positional information included in the positioning signal may be extracted by the terminal 530. The position of the pseudo satellite 500 may be estimated based on the positional information included in the positioning signal.

For example, the terminal 530 may receive a second positioning signal from a second pseudo satellite 520. The second positioning signal may include positional information of the second pseudo satellite 520, and may be received using the plurality of receiving antennas of the terminal 530.

A direction of the second pseudo satellite 520, which may be determined based on the terminal 530, may be estimated using the second positional signal received using the plurality of receiving antennas.

The positional information included in the second positioning signal may be extracted by the terminal 530. The position of the second pseudo satellite 520 may be estimated based on the positional information included in the second positioning signal.

In addition, the transmitting unit 510 may encode the positional signal using a PRN code. The transmitting unit 510 may transmit the encoded positional signal to the terminal 530. For example, the second pseudo satellite 520 may encode the second positioning signal using a second PRN code, and may transmit the encoded second positioning signal to the terminal.

Although a PRN code may be decoded readily using a corresponding PRN code, the PRN code may not be decoded using another PRN code. In this instance, the terminal 530 may decode each positioning signal using a PRN code applied to the each positioning signal, and may verify from which pseudo satellite the each positioning signal is transmitted.

The terminal 530 may estimate a position of the pseudo satellite 500 based on the positional information of the pseudo satellite 500, and may estimate a direction of the pseudo satellite 500, which may be determined based on the terminal 530, based on a phase difference of the positioning signal at each receiving antenna. Accordingly, the terminal 530 may compute back to the position of the terminal 530 from the position of the pseudo satellite 500. When the terminal 530 receives positioning signals from a plurality of pseudo satellites, for example, the pseudo satellite 500 and the second pseudo satellite 530, the terminal 530 may improve accuracy of estimation of the position of the terminal 530, using the positioning signals received from the pseudo satellite 500 and the second pseudo satellite 530, respectively.

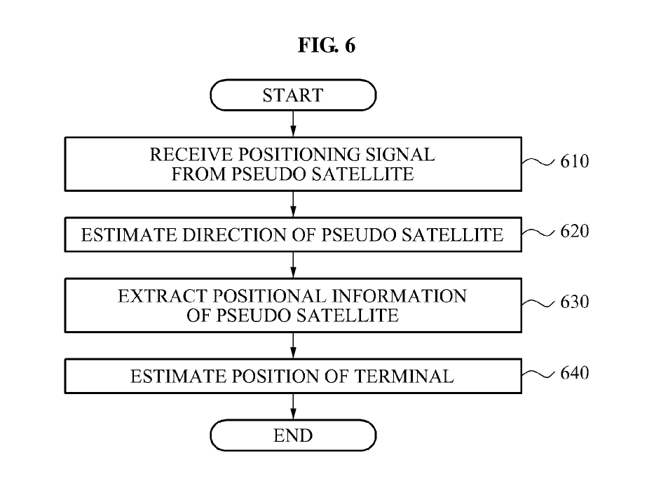

FIG. 6 is a flowchart illustrating an indoor positioning method according to an exemplary embodiment of the present invention.

Referring to FIG. 6, in operation 610, a terminal may receive a positioning signal from a pseudo satellite. Here, the pseudo satellite may be installed in an indoor environment in which a positioning signal may not be received from a satellite. In this instance, the terminal may receive the positioning signal using a plurality of receiving antennas.

The terminal may receive, from a plurality of pseudo satellites, positioning signals corresponding respectively to the plurality of pseudo satellites. In this instance, the plurality of pseudo satellites may encode the positioning signals using difference PRNs, and may transmit the encoded positioning signals. The terminal may search for a PRN code corresponding to each pseudo satellite, and may decode an encoded positioning signal received from a corresponding pseudo satellite, using a found PRN code. Since a positioning signal encoded using a predetermined PRN code may be decoded using only a corresponding PRN code, the terminal may distinguish positioning signals received from pseudo satellites, by searching for a PRN code corresponding to each pseudo satellite.

The terminal may receive the positioning signal from the pseudo satellite, using the plurality of receiving antennas, each being disposed a predetermined distance apart from one another. In operation 620, the terminal may estimate a direction of the pseudo satellite, based on a phase difference at each of the plurality of receiving antennas. The process of estimating a direction of a pseudo satellite based on a phase difference at each receiving antenna has been described with reference to FIG. 3 and thus, detailed descriptions will be omitted for conciseness.

The positioning signal may include positional information of the pseudo satellite. The positional information of the pseudo satellite may refer to information about a geographical position of the pseudo satellite, and may include at least one of longitude information, latitude information, and altitude information of the pseudo satellite.

In operation 630, the terminal may extract the positional information of the pseudo satellite by decoding the received positioning signal.

In operation 640, the terminal may verify a position of the pseudo satellite, and may estimate a position of the terminal, based on the verified position of the pseudo satellite, and the estimated direction of the pseudo satellite, which is determined based on the terminal. When the terminal receives positioning signals from a plurality of pseudo satellites, the terminal may improve accuracy of estimating the position of the terminal, using the positioning signals received from the plurality of pseudo satellites, respectively.

In the method of estimating the position according to an exemplary embodiment of the present invention, the terminal may estimate the position of the terminal, by decoding the positioning received from the plurality of pseudo satellites, separately. Accordingly, time synchronization among the plurality of pseudo satellites may be unnecessary, and the plurality of pseudo satellites may be managed conveniently.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A terminal, comprising:
a receiving unit to receive a first positioning signal from a first pseudo satellite, and to receive a second positioning signal from a second pseudo satellite, using a plurality of receiving antennas;
a direction estimating unit to estimate a direction of the first pseudo satellite based on a phase difference of the first positioning signal at the plurality of receiving antennas, and to estimate a direction of the second pseudo satellite based on a phase difference of the second positioning signal at the plurality of receiving antennas;
a positional information extracting unit to extract positional information of the first pseudo satellite by decoding the first positioning signal, and to extract positional information of the second pseudo satellite by decoding the second positioning signal; and
a position estimating unit to estimate a position of the terminal, based on the extracted positional information of the first pseudo satellite, the extracted positional information of the second pseudo satellite, the estimated direction of the first pseudo satellite, and the estimated direction of the second pseudo satellite.

2. The terminal of claim 1, wherein the first pseudo satellite and the second pseudo satellite are disposed indoors.

3. The terminal of claim 1, wherein each of the plurality of receiving antennas is disposed a predetermined distance apart from one another.

4. The terminal of claim 1, wherein the first positioning signal and the second positioning signal are encoded using different pseudo random noise (PRN) codes.

5. The terminal of claim 1, wherein
the positional information of the first pseudo satellite comprises at least one of longitude information, latitude information, and altitude information of the first pseudo satellite, and
the positional information of the second pseudo satellite comprises at least one of longitude information, latitude information, and altitude information of the second pseudo satellite.

6. A pseudo satellite, comprising:
a transmitting unit to transmit, to a terminal, a positioning signal comprising positional information of the pseudo satellite,
wherein
the positioning signal is received using a plurality of receiving antennas of the terminal, and the positional information and a direction of the pseudo satellite, estimated based on a phase difference at each of the plurality of receiving antennas, are used to estimate a position of the terminal.

7. The pseudo satellite of claim 6, wherein the positional information comprises at least one of longitude information, latitude information, and altitude information of the pseudo satellite.

8. The pseudo satellite of claim 6, wherein a second positioning signal is transmitted from a second pseudo satellite to the terminal, and received using the plurality of receiving antennas, and a direction of the second pseudo satellite, estimated based on a phase difference of the second positioning signal at each of the plurality of receiving antennas, is used to estimate the position of the terminal.

9. The pseudo satellite of claim 8, wherein the second positioning signal comprises positional information of the second pseudo satellite, and the positional information of the second pseudo satellite is used to estimate the position of the terminal.

10. The pseudo satellite of claim 8, wherein the transmitting unit encodes the positioning signal using a pseudo random noise (PRN) code, and transmits the encoded positioning signal.

11. A method of estimating a position of a terminal, the method comprising:
receiving a positioning signal from each of a plurality of pseudo satellites, using a plurality of receiving antennas;
estimating a direction of each of the plurality of pseudo satellites, based on a phase difference of the positioning signal at each of the plurality of antennas;
extracting positional information of each of the plurality of pseudo satellites, by decoding the positioning signal; and
estimating the position of the terminal, based on the extracted positional information of each of the plurality of pseudo satellites, and the estimated direction of each of the plurality of pseudo satellites.

12. The method of claim 11, wherein each of the plurality of receiving antennas is disposed a predetermined distance apart from one another.

13. The method of claim 11, wherein positioning signals are encoded using different pseudo random noise (PRN) codes.

14. The method of claim 11, the positional information of each of the plurality of pseudo satellites comprises at least one of longitude information, latitude information, and altitude information of each of the plurality of pseudo satellites.
